(19) United States
(12) Patent Application Publication
(10) Pub. No.: US 2021/0263174 A1
(43) Pub. Date: Aug. 26, 2021

(54) SEISMIC NODE, METHOD AND USE THEREOF FOR OCEAN BOTTOM SEISMIC SURVEYING

(71) Applicant: MAGSEIS FAIRFIELD ASA, Lysaker (NO)

(72) Inventors: Jan GATEMAN, Bekkestua (NO); Nils HEIEREN, Oslo (NO); Liam James FLOOD, Lysaker (NO)

(21) Appl. No.: 17/252,910

(22) PCT Filed: Jul. 9, 2019
(86) PCT No.: PCT/NO2019/050147

§ 371 Date: Dec. 16, 2020

(30) Foreign Application Priority Data
Jul. 10, 2018 (NO) 20180995

(51) Int. Cl. G01V 1/16; G01V 1/38

(52) U.S. Cl. CPC G01V 1/166; G01V 1/3852; G01V 2210/1423; G01V 2210/1427; G01V 1/3808

(57) ABSTRACT

A seismic node (1) for an ocean bottom seismic survey comprising: At least one seismic sensor capsule (2), a seafloor casing (6) comprising a lower surface configured to make contact with a seabed. The seismic sensor capsule (2) comprises first engagement means; the seafloor casing (6) comprises second engagement means (10). The first and second (10) engagement means are adapted to releasable engage with each other whereby the seismic sensor capsule (2) is releasably fastened to the seafloor casing (6). The seismic sensor capsule (2) is adapted to be removed from the seafloor casing (6) after a certain time T. The seafloor casing (6) is configured to be left permanently on the seabed.

The present invention relates to a seismic node for an ocean bottom seismic survey, the seismic node comprising:

At least one seismic sensor capsule comprising a first capsule surface and an opposite second capsule surface;

a seafloor casing comprising an upper surface and an opposite lower surface configured to make contact with a seabed.

The invention also relates to a method for performing an ocean bottom seismic survey the method comprising:

placing a seismic node comprising a seafloor casing and at least one seismic sensor capsule on a seafloor.

Further, the invention relates to use of the seismic node according to the invention for performing the method according to the invention.

It is known to use permanent seabed seismic systems for very precise repeatable Ocean Bottom Seismic surveys such as 4D or monitoring surveys. The permanent seabed seismic system is a system, which is not recovered between subsequent surveys, but is left on the seabed during its lifetime, and they are typically systems buried into the seabed or covered with rocks and similar. The sensors on the seabed are typically connected electrically/optically to a recording system on the surface so data is recorded in real time.

The main advantage of such systems is that each sensor stays in the same position all the time, so the position error between surveys is zero (unless the seabed itself changes, which it may do because of the field production). The sensitivity of a sensor varies from unit to unit, but by having the same sensor in the same location, the variation between subsequent surveys is cancelled if one disregards the effect of aging. The aging of a sensor is, however, not predictable, and can be a very serious problem. The sensors will change sensitivity at different rates over time, which will cause larger and larger response variation—which is the same as noise—on the recorded data.

The data integrity from a permanently installed system may be compromised over time as sensors fail, and these sensors are very expensive to replace, if at all possible.

Further, it is expensive to have sensors placed on the seabed between the surveys when they are not in use, so it would be desirable to increase the utilization of these between the surveys.

In other words, it is desirable to increase the utilization of the sensors and thereby reduce the costs of a survey, it is desirable to be able to reduce the risk for undesirable variation in the survey due to aging and thereby reducing the noise of the recorded data, and it is desirable to reduce sensor failures to prevent holes in the seismic dataset.

The present invention seeks generally to improve a seismic node for an ocean bottom seismic survey such that the abovementioned insufficiencies and drawbacks of today's permanently installed systems are overcome or at least it provides a useful alternative.

According to the invention, a seismic node for an ocean bottom seismic survey is provided, as per the introductory part of this specification, and wherein

the seismic sensor capsule comprises first engagement means, and that the seafloor casing comprises second engagement means,

said first and second engagement means are adapted to fit with each other whereby the seismic sensor capsule is releasably fastened to the seafloor casing,

said seismic sensor capsule is adapted to be removed from the seafloor casing after a certain time T and for being transported by a vehicle to a surface of the ocean, while the seafloor casing is configured to be left permanently on the seabed.

With such a seismic node system, which is a sort of semi-permanent system, a part of the seismic node—namely the seafloor casing part—is permanently placed on the seabed, while the seismic sensor capsule is releasably connected to the seafloor casing. With this system, it is possible to recover the sensor capsule to extract the recorded seismic data, and then to come back to the same place for the next survey and install another sensor capsule in the exact same location. The seafloor casings remain on the seabed for the entire monitoring contract period, maybe up to 10-20 years while the seismic sensor capsule is removed once a seismic survey is completed after 2-8 weeks or more. The seafloor casing is constructed so it stays in the same position on the seabed and has engagement means, which the sensor capsule can connect to or fit within with its mating engagement means. The first engagement means are preferably and at least placed at the capsule surface turning towards the seafloor casing. The second engagement means are preferably placed at the upper surface of the seafloor casing. The second engagement means may comprise a space/cavity placed in the upper surface of the seafloor casing. Then a part of the sensor capsule fits into the cavity which part is the first engagement means. By the expression “fit with” is to understand, that the engagement means are releasably engaged with each other but in such a way that the coupling between them makes the seismic sensor capsule immovably in relation to the seafloor casing, or they are adapted to snug/tight fit each other but still can be separated.

The seafloor casing is made of a rigid material so seismic energy is transferred into the inside of the sensor capsule and not attenuated.

It is appropriate that it also has one or more features, so it can be easily located from an Autonomous Underwater Vehicle (AUV) or a Remotely Operated Vehicle (ROV) or similar.

The sensor capsules are recovered after each survey, so instead of sitting idle on the seabed and connected to the seafloor casing, until the next survey in the same place (anywhere from 6 to 36 months later) takes place, the nodes can be used in other surveys. When a survey has to take place, the node is placed at the seabed and connected to the seafloor casing, which has been placed there all the time waiting for the next survey to take place. By this arrangement, the utilization of the assets—the sensor capsules—may go up and cost of the survey may go down.

The seismic sensor capsules may comprise an outer casing withstanding high water pressure and means for storing recorded data, sensors and a power supply unit. In one embodiment, it may contain three orthogonal geophones recording in x, y and z directions, a hydrophone, data recording unit and a battery for power supply and data storage unit. The batteries may be primary/non-rechargeable or secondary/rechargeable. A further description is found in U.S. Pat. No. 8,675,446, which hereby is incorporated by reference.

Further, the seafloor casing may have space for more than one seismic node capsule. It is also possible when two (or more) seismic node capsules are deployed into the capsule that one of them has a delayed starting time. In this way, the total recording time is extended.

According to one embodiment, the seismic sensor capsule is a water-tight pressure housing containing a seismic sensor pack and accessories such as electronics, seismic sensors, batteries, control units, memory cards.

The internal electrical components may include one or more hydrophones, one or more geophones or accelerometers, and a data recorder.

There are varieties of sensors that can be incorporated into the sensor capsule including and not exclusively, inclinometers, rotation sensors, translation sensors, heading sensors. The sensor capsule/housing is resistant to temperatures, pressures, and other seabed conditions (such as salinity) at the bottom of the ocean. Data can be retrieved from the sensor capsule while the sensor capsule is in a workstation or container on board of a marine vessel.

According to one embodiment, the bottom part of the seafloor casing comprises seafloor-casing friction means adapted to provide a friction force between the seabed and the seafloor casing; said friction force is larger than the hydrodynamic forces caused by the ocean current at the seabed.

The seafloor casing has to be designed so that it stays in the same position on the seabed. Further, it has the feature, which the sensor capsule can connect to or fit within. It must be made of a rigid material so seismic energy is transferred into the node and not attenuated. It should also have one or more features so it can be easily located from an ROV or similar. The friction means are preferably placed at least on the lower surface of the seafloor casing. The friction means may comprise a circumferential edge or the friction means may have the shape of knobs, ribs, sharp points and similar, and they may be made in concrete, metal, composites, polymers or a combination of these.

According to one embodiment, the seismic sensor capsule is adapted to be calibrated before deployment on the seabed, and said seismic sensor capsule is advantageously adapted to be calibrated after having been removed from the seafloor casing after the time T has passed.

The seismic sensors and any auxiliary sensors can be calibrated precisely so they all have virtually the same response. By doing this, any seismic sensor capsule can be deployed in any position on the seabed since the responses are matched. Further, the sensor capsules can be re-calibrated at a certain interval to remove the effect of aging and obtain a uniform response over time.

The sensor capsule contains the seismic sensors, which are calibrated so their responses to a seismic signal are the same. Since they are the same, any sensor capsule can be placed in any seafloor casing/position on the seabed.

The sensor capsules are assembled and started on the surface vessel before they are loaded into an ROV or an AUV for deployment on the seabed. When a sensor capsule is started, it runs a series on self-tests to verify that it functions correctly. When this is completed successfully, the sensor capsule can be deployed. In this way, it is possible to detect and remove defective sensor capsules and replace them. For a permanent system where the sensors are on the seabed for years and years, the operator will know if a sensor has failed, but he will not be able to replace it, hence there will be a hole in the dataset. Such holes in the dataset are avoided by the present invention.

Further, the proposed system and method gives the client the flexibility to adapt the receiver positions to observations from previous surveys. It may, for instance, be that a certain area should be monitored more closely, so the receiver grid should be denser there and maybe sparser in other areas. With a permanent system, this is not possible.

According to one embodiment, the seafloor casing left at the seabed after the seismic sensor capsule has been removed is adapted to engage with a new seismic sensor capsule,

said new seismic sensor capsule is the same as has been removed but is advantageously in a calibrated state, or the seismic sensor capsule is different from the removed seismic sensor capsule and is advantageously in a calibrated state.

The sensor capsules are recovered from the seafloor casing by an ROV or an AUV and might be brought to a surface vessel. In another embodiment, the retrieval of the seismic data from the sensor capsule may be performed directly from the sensor capsule for instance by wireless techniques. Due to the sensor capsules are calibrated, it does not matter which sensor capsule that has been chosen for being placed at the seabed and connected to a seafloor casing, which is a part of the survey.

According to one embodiment, the seafloor casing comprises passive acoustic reflectors or similar means. The purpose of the passive reflector is for an ROV or AUV to locate the position of the seafloor casing/sensor capsule easily from a distance using an echosounder. This will in particular be efficient if the visibility is poor. The passive reflector is a part of or attached to the seafloor casing. If a product such as “Sonarbell” is used, it can be attached to the seafloor casing with a short piece of string, or there can be a piece of rope from the seafloor casing to an anchor and then the positively buoyant “Sonarbell” is attached to the anchor.

According to one embodiment, the first and second engagement means comprises a tight fit between the seismic sensor capsule and the seafloor casing.

According to one embodiment, the seismic node comprises at least two seismic sensor capsules, which fit with one seafloor casing.

According to the invention, a method for performing an ocean bottom seismic survey is provided, as per the introductory part of this specification, and wherein

the seismic sensor capsule(s) is/are releasably attached to the seafloor casing, and that the seismic sensor capsule(s) is/are removed from the seafloor casing by a vehicle, after a certain time T has passed,

said seismic sensor capsule(s) is/are transported to a surface vessel where data registered by the seismic sensor capsule(s) are extracted from the seismic sensor capsule(s) or the data are extracted while the seismic sensor capsule(s) is/are still in the ocean, while the seafloor casing is left permanently at the same place of the seabed,

said seafloor casing is a stationary and immovable unit.

By immovable is to understand that the seafloor casing when placed at the seabed is not in a condition to be moved by external forces unless this is a vehicle or similar with the purpose to move the seafloor casing away from the original place.

According to one embodiment, a seismic sensor capsule is calibrated and the calibrated seismic sensor capsule is transported by the vehicle to any stationary and immovable seafloor casing placed at the seabed for performing the seismic survey.

According to one embodiment, at least one seismic sensor capsule is installed in the seafloor casing left at the seabed, said seismic sensor capsule(s) is/are recording passive data until a next planned survey is performed.

According to one embodiment, the vehicle is carrying at least one dummy seismic sensor capsule, which is installed in the seafloor casing after the seismic sensor capsule(s) has/have been removed.

The dummy seismic sensor capsule has such a weight that the buoyancy of the vehicle remains constant throughout the mission. Hereby all available power in the vehicle can be used for propulsion/speed instead of providing downforce or lift as the payload varies with the number of seismic sensor capsules it carries.

According to one embodiment, the vehicle is a Remotely Operated Vehicle (ROV) or an Autonomous Underwater Vehicle (AUV).

The invention is also related to use of a seismic node according to the invention for performing the method as disclosed above.

### BRIEF DESCRIPTION OF THE DRAWINGS

FIG. 1A is a perspective view of a seismic node according to the invention, comprising a sensor capsule and a seafloor casing.

FIG. 1B is a perspective view of a seafloor casing according to the invention.

FIG. 1C is a view of the seafloor casing shown in FIG. 1B along the longitudinal side of the seafloor casing.

FIG. 1D is a view of the seafloor casing shown in FIG. 1B along the short side of the seafloor casing.

FIG. 1E is a view of the seafloor casing shown in FIG. 1B shown from the bottom side and disclosing seafloor-casing friction-means.

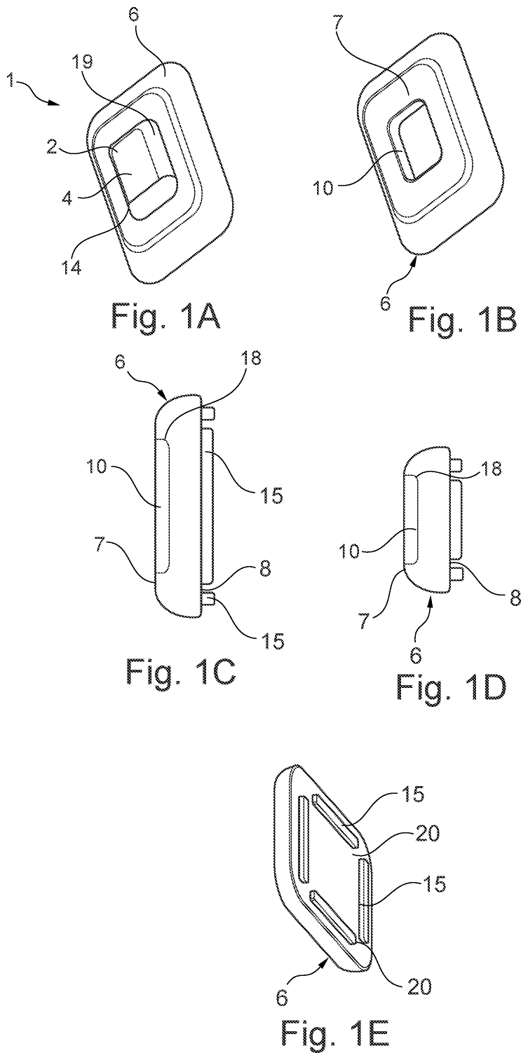

The invention will be explained with reference to FIG. 1A-E, FIG. 1A showing a perspective view of a seismic node 1 used for an ocean bottom seismic survey. It comprises a seafloor casing 6 and a seismic sensor capsule 2. The seismic sensor capsule 2 is attached to the upper surface 7 of the seafloor casing 6. The sensor capsule 2 comprises a first capsule surface 4 comprising features exposed to the water when the device 1 is placed at a seabed during a survey. The sensor capsule 2 is a watertight pressure housing 14 inside which different components are placed and protected by the housing 14. The components may be electronics, seismic sensors, batteries, memory card etc. and may include one or more hydrophones, one or more geophones or accelerometers, and a data recorder.

The sensor capsule 2 is attached to the seafloor casing 6; the seafloor casing 6 is shown in detail in FIG. 1B-1E.

The seafloor casing 6 comprises the upper surface 7 and an opposite lower surface 8. The lower surface 8 is configured to make contact with the seabed. The upper surface 7 comprises in this embodiment a cavity. The cavity is shown with dotted lines 18 in FIG. 1C and FIG. 1D. The cavity forms second engagement means 10 engaging with first engagement means of the seismic sensor capsule. The cavity simply encloses the bottom capsule surface—the surface turning towards the seafloor casing 6—and a portion of sidewalls 19 of the seismic sensor capsule 2. The bottom capsule surface and the portion of the sidewalls 19 form first engagement means.

The first and second 10 engagement means is thereby working by press fit. The seafloor casing 6 in this case has a region of the upper surface 7 formed as the cavity/recess which is shaped like the sensor capsule 2, so it is well coupled to the seafloor casing 6.

The first and second 10 engagement means could also comprise mechanical means such as projections in one part engaging recesses in the other part.

The outside of the seismic sensor capsule might also comprise recesses or projections such that a vehicle—an ROV or an AUV—is able to easily grab the seismic sensor capsule 2 when it has to be removed from the seafloor casing 6.

The lower surface 8 is configured to make contact with the seabed and comprises seafloor-casing friction-means 15 in order to optimize the contact between the seafloor casing 6 and the seabed in such a way that the seafloor casing 6 does not move during its stay on the seabed.

The seafloor-casing friction-means 15 is in this embodiment formed as a circumferential edge/long ridges extending from the bottom 8 of the seafloor casing 6. The circumferential edge has through-going openings 20 placed in each corner of the bottom 8 of the seafloor casing 6. When placing the seafloor casing 6 on the seabed, the water is not trapped by the circumferential edge. The seafloor-casing friction means 15 could be constructed in other ways such as small half-spheres.

When a survey has been conducted and the seismic sensor capsule is to be removed from the seafloor casing an ROV or an AUV is directed to the seismic node. The ROV or AUV must be able to carry the sensor capsule and have tools to deploy and recover them. The seafloor casing is equipped with devices that makes it possible for the vehicle to detect its position. These devices are for instance passive acoustic reflectors that reflects acoustics waves send from the vehicle.

The passive acoustic reflectors are advantageously placed on or adjacent to the seafloor casing 6, so the vehicle is able to detect the seafloor casing 6 when a new survey has to take place, and a seismic sensor capsule 2 therefor must be attached to the seafloor casing 6. An ROV pilot may also use the ROV's navigation system and cameras to navigate to the position of the seafloor casing. However, when the ROV is equipped with an echosounder, it is possible to locate the positioning device by the passive acoustic reflector if the visibility is poor.

The sensor capsules 2 are recovered from the seafloor casing 6 by the ROV or AUV and brought to a surface vessel. There, the sensor capsules 2 are handled in the same way as cable-based sensor capsules: the control unit, which contains the memory card, is removed from the sensor capsule and mated in a docking cabinet where it connects to the central data network and the data is downloaded.

1-13. (canceled)

14. A seismic node for an ocean bottom seismic survey, the seismic node comprising:
at least one seismic sensor capsule comprising a first capsule surface and an opposite second capsule surface; and
a seafloor casing comprising an upper surface and an opposite lower surface configured to make contact with a seabed,
wherein the seismic sensor capsule comprises first engagement means, and that the seafloor casing comprises second engagement means,
said first and second engagement means are adapted to fit with each other whereby the seismic sensor capsule is releasably fastened to the seafloor casing,
said seismic sensor capsule is adapted to be removed from the seafloor casing after a certain time T and for being transported by a vehicle to a surface of the ocean, while the seafloor casing is configured to be left permanently on the seabed.

15. The seismic node according to claim 14, wherein the seismic sensor capsule is a water-tight pressure housing containing a seismic sensor pack and accessories such as electronics, seismic sensors, batteries, control units, memory cards.

16. The seismic node according to claim 14, wherein the seafloor casing comprises seafloor-casing friction-means adapted to provide a friction force between the seabed and the seafloor casing said friction force is larger than the hydrodynamic forces provided by the ocean current at the seabed.

17. The seismic node according to claim 14, wherein the seismic sensor capsule is adapted to be calibrated before deployment on the seabed, and said seismic sensor capsule is advantageously adapted to be calibrated after having been removed from the seafloor casing after the time T has passed.3

18. The seismic node according to claim 14, that the seafloor casing left at the seabed after the seismic sensor capsule has been removed is adapted to engage with a new seismic sensor capsule, said new seismic sensor capsule is the same as has been removed but is advantageously in a calibrated state, or the seismic sensor capsule is different from the removed seismic sensor capsule and advantageously in a calibrated state.

19. The seismic node according to claim 14, wherein the seafloor casing comprises passive acoustic reflectors or similar means.

20. The seismic node according to claim 14, wherein the first and second engagement means comprises a tight fit between the seismic sensor capsule and the seafloor casing.

21. A method for performing an ocean bottom seismic survey the method comprising:
placing a seismic node comprising a seafloor casing and at least one seismic sensor capsule on a seafloor, wherein the seismic sensor capsule(s) is/are releasably attached to the seafloor casing, and that the seismic sensor capsule(s) is/are removed from the seafloor casing by a vehicle, after a certain time T has passed, said seismic sensor capsule(s) is/are transported to a surface vessel where data registered by the seismic sensor capsule(s) are extracted from the seismic sensor capsule(s), or the data are extracted while the seismic sensor capsule(s) is/are still in the ocean, while the seafloor casing is left permanently at the same place of the seabed, said seafloor casing is a stationary and immovable unit.

22. The method according to claim 21, wherein a seismic sensor capsule is calibrated and that the calibrated seismic sensor capsule is transported by the vehicle to any stationary and immovable seafloor casing placed at the seabed for performing the seismic survey.

23. The method according to claim 21, wherein at least one seismic sensor capsule is installed in the seafloor casing left at the seabed, said seismic sensor capsule(s) is/are recording passive data until a next planned survey is performed.

24. The method according to claim 21, wherein the vehicle is carrying at least one dummy seismic sensor capsule, which is installed in the seafloor casing after the seismic sensor capsule(s) has/have been removed.

25. The method according to claim 21, wherein the vehicle is a Remotely Operated Vehicle (ROV) or an Autonomous Underwater Vehicle (AUV).

26. Use of the seismic node comprising:
at least one seismic sensor capsule comprising a first capsule surface and an opposite second capsule surface; and
a seafloor casing comprising an upper surface and an opposite lower surface configured to make contact with a seabed,
wherein the seismic sensor capsule comprises first engagement means, and that the seafloor casing comprises second engagement means,
said first and second engagement means are adapted to fit with each other whereby the seismic sensor capsule is releasably fastened to the seafloor casing,
said seismic sensor capsule is adapted to be removed from the seafloor casing after a certain time T and for being transported by a vehicle to a surface of the ocean, while the seafloor casing is configured to be left permanently on the seabed, for performing the method according to claim 21.
